(19) United States
(12) Patent Application Publication
(10) Pub. No.: US 2023/0184475 A1
(43) Pub. Date: Jun. 15, 2023

(54) REFRIGERATION CYCLE APPARATUS

(71) Applicant: Mitsubishi Electric Corporation, Tokyo (JP)

(72) Inventors: Shun OKADA, Tokyo (JP); Masaaki KAMIKAWA, Tokyo (JP); Masahiro KANDA, Tokyo (JP)

(21) Appl. No.: 18/003,178

(22) PCT Filed: Aug. 26, 2020
(86) PCT No.: PCT/JP2020/032117

§ 371 Date: Dec. 23, 2022

(51) Int. Cl. F25B 49/02; F25B 31/02

(52) U.S. Cl. CPC F25B 49/022; F25B 31/026; F25B 2500/26; F25B 2600/2501; F25B 2700/21151; F25B 2700/1933

(57) ABSTRACT

A refrigeration cycle apparatus comprises: a refrigerant cycle circuit, a condenser, a pressure-reducing device and an evaporator are sequentially connected by pipes; an injection circuit that branches off from the refrigerant cycle circuit between the condenser and the pressure-reducing device and is connected to the injection flow passage; a flow rate control device provided in the injection circuit or the injection flow passage; and a controller configured to control the flow rate control device. At a time of starting up the compressor, the controller, controls regardless of a temperature of refrigerant discharged from the compressor, the flow rate control device so as to supply refrigerant liquid to the compression chamber via the injection circuit and the injection flow passage until an operating capacity of the compressor reaches a preset operating capacity or until a preset time elapses after starting up the compressor.

### TECHNICAL FIELD

The present disclosure relates to a refrigeration cycle apparatus provided with a compressor.

### BACKGROUND ART

A refrigeration cycle apparatus provided with a refrigerant cycle circuit in which a compressor, a condenser, a pressure-reducing device, and an evaporator are sequentially connected by pipes has heretofore been known. In such a refrigeration cycle apparatus, a high-pressure section extending from a discharge port of a compressor to an inlet of a condenser may become abnormally hot, causing refrigerant and oil to deteriorate, and if the compressor is a screw compressor, for example, a screw rotor may thermally expand excessively and contact the casing, causing the screw rotor and the casing to suffer from seizure.

For example, in the screw refrigeration apparatus disclosed in Patent Reference 1, an injection passage is provided to inject refrigerant liquid discharged from a condenser into a compression chamber of a screw compressor, and a temperature-sensitive expansion valve is provided in the injection passage. This screw refrigeration apparatus is configured to prevent a screw rotor from becoming abnormally hot by adjusting the opening degree of the temperature-sensitive expansion valve based on the discharge temperature of the screw compressor, and to control a degree of superheat of a discharge gas at a constant level.

### CITATION LIST

### Patent Literature

Patent Literature 1: Japanese Unexamined Patent Application Publication No. H05-10613

### SUMMARY OF INVENTION

### Technical Problem

In a refrigeration cycle apparatus, at the time of starting up a compressor, a suction pressure of the compressor tends to drop, and since the compressor is operated at a lower capacity, an amount of refrigerant circulating may be reduced. Generally, as a method for preventing abnormal rise in a discharge temperature in an injection circuit, as in the case of the screw refrigeration apparatus disclosed in Patent Reference 1, a method in which a flow rate of the injection circuit is controlled by using a temperature-sensitive expansion valve, or a method in which values detected by a discharge temperature sensor are used to control supply of refrigerant liquid through the injection circuit so as to prevent a discharge temperature from rising above a set temperature, or other methods can be considered. However, with these control methods, at the time of starting up a compressor, if the amount of refrigerant circulating is small to cause the temperature and the pressure to change rapidly, detection of the discharge temperature of the compressor is delayed, and as a result, a reaction speed required to open the temperature-sensitive expansion valve becomes slow. As a result, the refrigerant liquid is not supplied sufficiently from the injection passage to the compression chamber, and if the compressor is, for example, a screw compressor, the discharge temperature rises excessively, and the amount of expansion of the screw rotor increases, which may cause the screw rotor and the casing to contact each other and to result in seizure.

The present disclosure has been made to solve the problem mentioned above, and an object thereof is to provide a refrigeration cycle apparatus that can sufficiently supply refrigerant liquid from an injection circuit to a compression chamber at the time of starting up a compressor and, when the compressor is, for example, a screw compressor, can prevent a screw rotor and a casing from contacting each other and suffering from seizure.

### Solution to Problem

A refrigeration cycle apparatus according to one embodiment of the present disclosure is a refrigeration cycle apparatus comprising: a refrigerant cycle circuit in which a compressor including a compression chamber configured to compress refrigerant and an injection flow passage that leads to the compression chamber, a condenser; a pressure-reducing device and an evaporator are sequentially connected by pipes; an injection circuit that branches off from the refrigerant cycle circuit between the condenser and the pressure-reducing device and is connected to the injection flow passage; a flow rate control device provided in the injection circuit or the injection flow passage; and a controller configured to control the flow rate control device, wherein, at a time of starting up the compressor, the controller is configured to control, regardless of a temperature of refrigerant discharged from the compressor, the flow rate control device so as to supply refrigerant liquid to the compression chamber via the injection circuit and the injection flow passage until an operating capacity of the compressor reaches a preset operating capacity or until a preset time elapses after starting up the compressor.

### Advantageous Effects of Invention

The refrigeration cycle apparatus according to one embodiment of the present disclosure controls a flow rate control device to supply refrigerant liquid to a compression chamber via an injection circuit and an injection flow passage at the time of starting up the compressor, regardless of a discharge temperature of refrigerant discharged from the compressor, until an operating capacity of the compressor reaches a preset operating capacity or until a preset time elapses after the compressor starts up. Therefore, when the compressor starts up, refrigerant liquid can be supplied sufficiently from the injection circuit to the compression chamber; thereby preventing an abnormal rise in discharge temperature and, when the compressor is a screw compressor, for example, preventing a circumstance in which the screw rotor and the casing contact each other to result in seizure.

### BRIEF DESCRIPTION OF DRAWINGS

FIG. 1 is a refrigerant circuit diagram of the refrigeration cycle apparatus according to Embodiment 1.

FIG. 2 is a schematic cross-sectional view of a screw compressor of the refrigeration cycle apparatus according to Embodiment 1.

FIG. 3 is a cross-sectional view as viewed from arrows A-A in FIG. 2

FIG. 4 is an explanatory diagram showing a compression principle of the screw compressor in Embodiment 1,

FIG. 5 is a graph illustrating control of the screw compressor according to Embodiment 1.

FIG. 6 is a refrigerant circuit diagram illustrating a modification example of the refrigeration cycle apparatus according to Embodiment 1.

FIG. 7 is a refrigerant circuit diagram of the refrigeration cycle apparatus according to Embodiment 2.

FIG. 8 is a cross-sectional view schematically illustrating a screw compressor of the refrigeration cycle apparatus according to Embodiment 2.

FIG. 9 is a refrigerant circuit diagram of the refrigeration cycle apparatus according to Embodiment 3.

### DESCRIPTION OF EMBODIMENTS

Hereinbelow, embodiments of the present disclosure will be explained with reference to the drawings. In each drawing, the same or equivalent parts are indicated by the same reference signs, and an explanation thereof is appropriately omitted or simplified. As for the configuration of devices or components described in each figure, the shape, size, arrangement or the like thereof can be appropriately changed.

### Embodiment 1

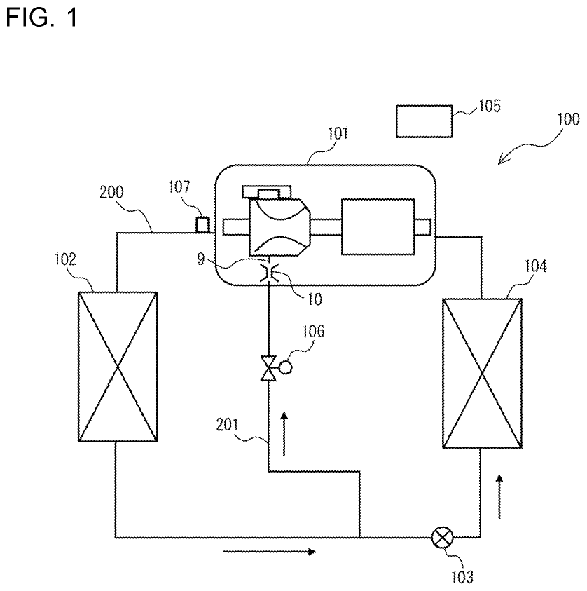

FIG. 1 is a refrigerant circuit diagram of the refrigeration cycle apparatus according to Embodiment 1. The refrigeration cycle apparatus 100 according to Embodiment 1 is used, for example, in an air-conditioning apparatus, a refrigeration apparatus, a refrigerator, a freezer, a vending machine, or a hot water supply unit. As illustrated in FIG. 1, this refrigeration cycle apparatus 100 includes the refrigerant cycle circuit 200 in which a compressor 101, a condenser 102, a pressure-reducing device 103, and an evaporator 104 are connected sequentially by the refrigerant pipes, and through which mainstream refrigerant circulates. The refrigeration cycle apparatus 100 also has the controller 105 configured to control each component.

One example of the compressor 101 in Embodiment 1 is a screw compressor 101. The screw compressor 101 compresses sucked refrigerant and discharges compressed refrigerant in a high-temperature and high-pressure state. The screw compressor 101 has an injection flow passage 9 leading to compression chambers 40 where refrigerant is compressed. The condenser 102 condenses gaseous refrigerant discharged from the screw compressor 101. The pressure-reducing device 103 decompresses and expands refrigerant discharged from the condenser 102, and one of examples of the pressure-reducing device 103 is an electronic expansion valve of which the opening degree is variably controlled. The evaporator 104 evaporates refrigerant that flows out of the pressure-reducing device 103.

The controller 105 is an arithmetic device, such as a microcomputer, and software executed by the arithmetic device. The controller 105 may also be hardware, such as a circuit device that implements its functions.

The refrigeration cycle apparatus 100 also includes an injection circuit 201, which branches off from a refrigerant pipe between the condenser 102 and the pressure-reducing device 103 and is connected to the injection flow passage 9 of the screw compressor 101. The injection circuit 201 is provided with a flow passage opening and closing device 106, which opens and closes the injection circuit 201 as part of the flow rate control device. The flow passage opening and closing device 106 is, for example, a solenoid valve.

The refrigeration cycle apparatus 100 is also provided with a temperature detector 107 configured to detect a temperature of a discharge gas discharged from the screw compressor 101. The temperature detector 107 is, for example, a temperature sensor. The temperature detector 107 is installed in the screw compressor 101 or in the refrigerant cycle circuit 200. A temperature detected by the temperature detector 107 is output to the controller 105.

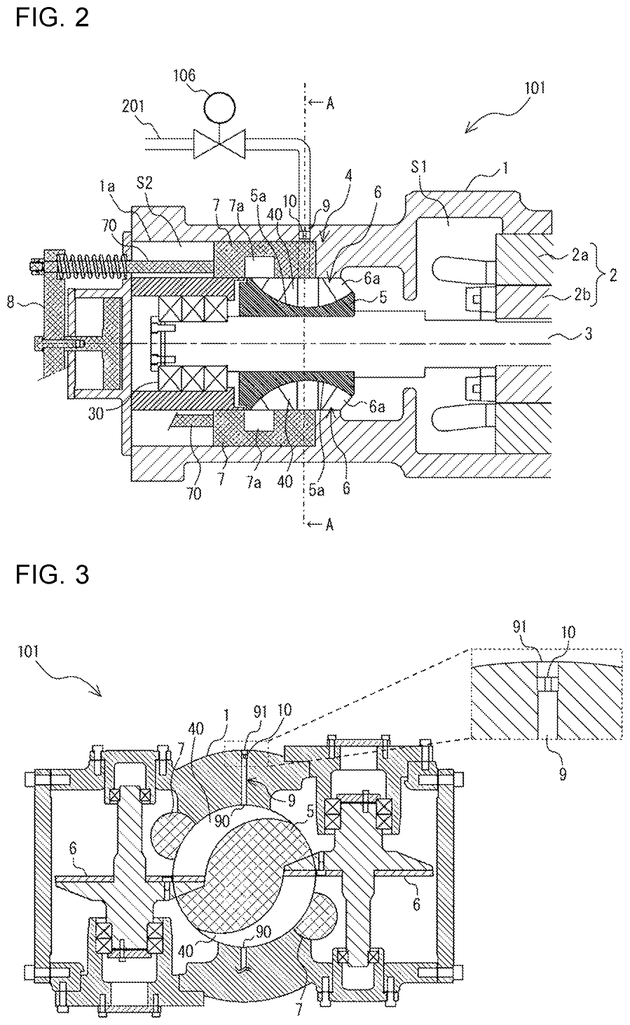

Next, the configuration of the screw compressor 101 will be explained with reference to FIGS. 2 and 3. FIG. 2 is a schematic cross-sectional view of the screw compressor of the refrigeration cycle apparatus according to Embodiment 1. FIG. 3 is a cross-sectional view as viewed from arrows A-A in FIG. 2.

As illustrated in FIGS. 2 and 3, the screw compressor 101 has a casing 1 that forms an outer contour, an electric motor 2, a screw shaft 3, which is driven to rotate by the electric motor 2, and a compression mechanism 4, which compresses refrigerant by a driving force transmitted from the screw shaft 3.

The casing 1 is cylindrical in shape and contains in the inside thereof the electric motor 2 and the compression mechanism 4. The inside of the casing 1 is divided into a low-pressure space S1 provided on the suction side of the compression mechanism 4 and a high-pressure space S2 provided on the discharge side of the compression mechanism 4. The low-pressure space S1 is in an atmosphere of a suction pressure and is a space into which low-pressure refrigerant gas flows from the evaporator 104 in the refrigerant cycle circuit 200, and also is a space that guides the low-pressure gas to the compression mechanism 4. The high-pressure space S2 is in an atmosphere of a discharge pressure and is a space from which refrigerant gas compressed by the compression mechanism 4 is discharged.

The electric motor 2 has a stator 2a internally contacts and is fixed to the inside of the casing 1 and a motor rotor 2b that is positioned inside the stator 2a in a rotatable manner. The electric motor 2 may be a constant speed motor with a constant drive frequency, or an inverter motor driven with its capacity being adjustable by changing the drive frequency. The electric motor 2 is located in the low-pressure space S1 and is cooled by low-pressure refrigerant gas. The motor rotor 2b is fixed to the screw shaft 3. The screw compressor 101 has a configuration in which the screw shaft 3 rotates by driving of the electric motor 2.

The compression mechanism 4 has a screw rotor 5, a pair of gate rotors 6, and a pair of slide valves 7.

The screw rotor 5 is a cylindrical body with multiple screw grooves 5a, which are each helically shaped, on its outer peripheral surface. The screw rotor 5 is fixed to the screw shaft 3 and is located coaxially with the motor rotor 2b. The screw rotor 5 rotates with the screw shaft 3, which is rotated by the electric motor 2. In the screw rotor 5, the low-pressure space S1 side in the direction of the rotational axis serves as the refrigerant suction side, and the screw grooves 5a communicate with the low-pressure space S1. Further, in the screw rotor 5, the high-pressure space S2 side in the direction of the rotational axis serves as the refrigerant discharge side, and the screw groove 5a communicates with the high-pressure space S2.

The gate rotors 6 each have, on its outer periphery, a plurality of gate rotor teeth 6a which are configured to mesh with the screw grooves 5a of the screw rotor 5. The pair of gate rotors 6 are positioned so as to sandwich the screw rotor 5 in the radial direction. The compression chambers 40, in which refrigerant gas is compressed, are each a space enclosed by the screw groove 5a of the screw rotor 5, the gate rotor teeth 6a of the gate rotor 6, the inner cylinder surface of the casing 1, and the slide valve 7. The screw compressor 101 includes two gate rotors 6 arranged so as to face each other in such a manner that one gate rotor 6 is shifted by 180 degrees against the other gate rotor 6 relative to the screw rotor 5, and hence, the screw compressor 101 has two compression chambers 40; specifically, one on the upper side of the screw shaft 3 and the other on the lower side of the screw shaft 3. Oil is injected into the compression chambers 40 to lubricate the bearing 30 of the screw shaft 3 and seal the compression chambers 40.

As illustrated in FIG. 2, the slide valves 7 are located in the slide groove 1a formed in the inner cylindrical surface of the casing 1, and can slide freely in the direction of the rotational axis of the screw rotor 5. The slide valves 7 each have a discharge port 7a through which refrigerant compressed in the compression chambers 40 is discharged. Refrigerant compressed in the compression chambers 40 is discharged from the discharge port 7a into the high-pressure space S2.

The slide valves 7 are a mechanical capacity control mechanism that adjusts the size of a bypass port between the compression chambers 40 and the low-pressure space S1 by moving the screw shaft 3 in the axial direction. By adjusting the size of the bypass port, the flow rate of refrigerant flowing from the compression chambers 40 to the low-pressure space S1 through the bypass port changes. As a result, the flow rate of refrigerant compressed in and discharged from the compression chambers 40 change, and the flow rate of refrigerant discharged from the screw compressor 101, i.e., the operating capacity of the screw compressor 101 changes.

The slide valves 7 are not limited to the mechanical capacity control mechanism, and may be, for example, a variable internal capacity ratio mechanism in which the timing of discharge from the compression chambers 40 is adjusted to allow the internal capacity ratio to be variable. Here, the internal capacity ratio indicates a ratio between the capacity of the compression chambers 40 at completion of suction (at the start-up of compression) and the capacity of the compression chambers 40 just before discharge.

The slide valves 7 are each connected to a bypass drive unit 8, such as a piston, for example, via a connection rod 70. By the driving of the bypass drive unit 8, the slide valves 7 move in the axial direction of the screw shaft 3 in the slide groove 1a.

The screw compressor 101 performs a capacity control operation in which the position of the slide valves 7 are controlled so as to adjust the amount of refrigerant discharged from the discharge port 7a of the compression chambers 40. This capacity control operation is performed by sending instructions from the controller 105 to the bypass drive unit 8 to position the slide valves 7 to adjust the amount of discharged refrigerant. Here, a power source for driving the bypass drive unit 8, which drives the slide valves 7 are not particularly limited. The bypass drive unit 8 may be one driven by gas pressure, may be one driven by hydraulic pressure, or may be one driven by a motor or other sources separately from the piston, or the like.

As illustrated in FIGS. 2 and 3, the screw compressor 101 having the above-mentioned configuration is provided with the injection flow passage 9 which is formed as a through hole in the casing 1 and leads to the compression chambers 40. The injection flow passage 9 is provided with a fixed expansion component 10 as the flow rate control device. The fixed expansion component 10 acts as a flow rate control device together with the flow passage opening and closing device 106. The fixed expansion component 10 is, for example, an orifice plug. After passing through the fixed expansion component 10, the injection flow passage 9 branches in the casing 1 and the branched passages respectively communicate with the two compression chambers 40 shown at the top and the bottom of FIG. 3. In the injection flow passage 9, the injection port 90, which is an opening on the screw rotor 5 side, communicates with the compression chambers 40. In the injection flow passage 9, the injection circuit 201 is connected to a connection port 91, which is an opening on the opposite side of the screw rotor 5. The fixed expansion component 10 may have a configuration in which, for example, a capillary tube or the like is installed in the injection circuit 201 in addition to the orifice plug.

In the refrigeration cycle apparatus 100 according to Embodiment 1, refrigerant that flows out of the condenser 102 and branches off from refrigerant cycle circuit 200 to the injection circuit 201 flows into the injection flow passage 9 after passing through the flow passage opening and closing device 106. Refrigerant that flows into the injection passage 9, of which the flow rate is adjusted by the fixed expansion component 10, is injected from the injection port 90 into the compression chambers 40.

### (Explanation on Operation of Refrigeration Cycle Apparatus 100)

Next, operation of the refrigeration cycle apparatus 100 according to Embodiment 1 will be explained with reference to FIG. 1.

The screw compressor 101 sucks refrigerant gas, which is refrigerant in a gaseous state, compresses it, and then discharges the compressed refrigerant gas. Refrigerant gas discharged from the screw compressor 101 is cooled by the condenser 102. Refrigerant liquid cooled by the condenser 102 and flows out therefrom is divided into mainstream refrigerant that flows through refrigerant cycle circuit 200 and injection refrigerant that branches off from the mainstream refrigerant and flows through the injection circuit 201. The mainstream refrigerant that flows through refrigerant cycle circuit 200 is decompressed by the pressure-reducing device 103 to expand, and then is heated by the evaporator 104 to turn into refrigerant gas. Refrigerant gas that flows out of the evaporator 104 is sucked into the screw compressor 101.

When the flow passage opening and closing device 106 is open, refrigerant liquid that branches off into the injection circuit 201 passes, after passing through the injection circuit 201, through the injection flow passage 9 provided in the casing 1, and is depressurized by the fixed expansion component 10. Then, the refrigerant liquid is injected from the injection port 90 into the compression chambers 40 by a difference in pressure between the pressure of the decompressed refrigerant liquid and the pressure in the compression chambers 40. The injected refrigerant liquid is mixed with the refrigerant gas in the process of compression, compressed together with the refrigerant gas, and then discharged from the screw compressor 101.

### (Explanation on Operation of Screw Compressor 101)

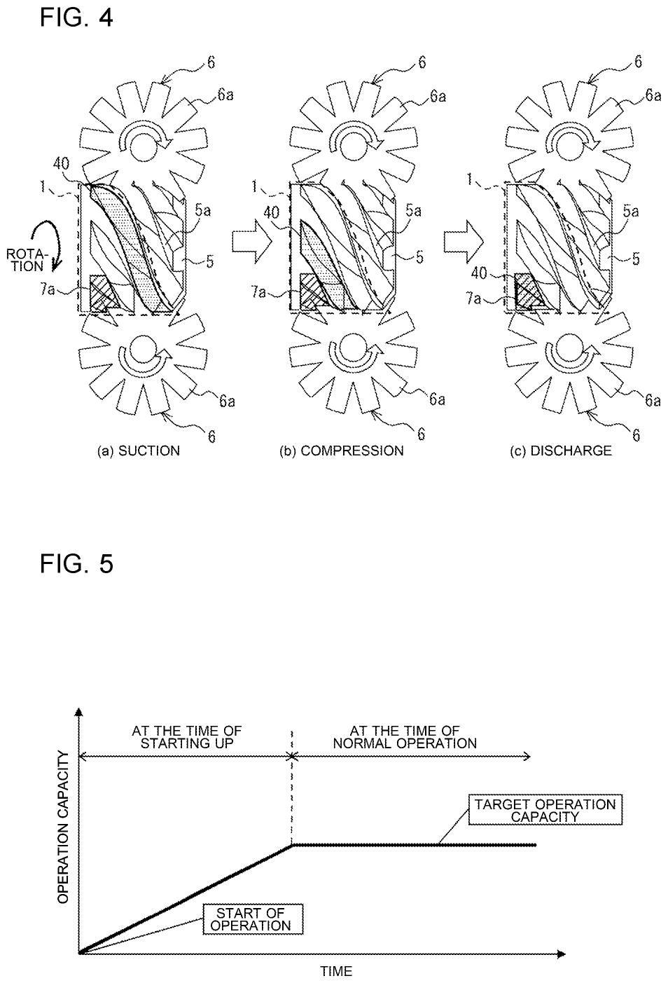

Next, the operation of the screw compressor 101 will be explained with reference to FIG. 4. FIG. 4 is an explanatory diagram showing the compression principle of the screw compressor in Embodiment 1. FIG. 4(a) illustrates the state of the compression chambers 40 in the suction process. FIG. 4(b) illustrates the state of the compression chambers 40 in the compression process. FIG. 4(c) illustrates the state of the compression chambers 40 in the discharge process.

In the screw compressor 101, when the screw rotor 5 rotates via the screw shaft 3, which is rotated by the driving of the electric motor 2, as illustrated in FIG. 4, the gate rotor teeth 6a of the gate rotor 6 moves relatively in the screw grooves 5a forming the compression chambers 40. At this time, in the compression chambers 40, the suction process (a), the compression process (b), and the discharge process (c) are sequentially performed. In the screw compressor 101, the suction process (a), the compression process (b), and the discharge process (c) are regarded as a single cycle, and this cycle is repeated. Here, each process will be described. In the following explanation, a focus is made on the compression chambers 40 shown by the dot-shaped hatching in FIG. 4.

In the suction process (a), the screw rotor 5 is rotated in the direction of the solid arrow by driving the electric motor 2. When the screw rotor 5 rotates, the capacity of the compression chambers 40 decreases as illustrated in FIG. 4(b).

Subsequently, when the screw rotor 5 rotates, as illustrated in FIG. 4(c), the compression chambers 40 communicates with the outside via the discharge port 7a. As a result, the high-pressure refrigerant gas compressed in the compression chambers 40 is discharged to the outside from the discharge port 7a. Then, the similar compression is performed again on the back surface of the screw rotor 5.

In FIG. 4, illustration of the injection port 90, the slide valve 7, and the slide groove 1a is omitted. The refrigerant liquid that has passed through the injection flow passage 9 flows into the compression chambers 40 through the injection port 90 in the compression process (b), is compressed together with the refrigerant gas, and is then discharged to the outside in the discharge process (c).

### (During Normal Operation of Screw Compressor 101)

Next, control of the discharge temperature during normal operation of screw compressor 101 will be described with reference to FIG. 5. FIG. 5 is a graph illustrating control of the screw compressor according to Embodiment 1. As illustrated in FIG. 5, the normal operation of the screw compressor 101 means a state in which the operating capacity reaches a target operating capacity as a result of gradual increase in operating capacity after starting up the screw compressor 101.

In the screw compressor 101, when the discharge temperature rises excessively, the refrigerant and the oil deteriorate or a gap between the screw rotor 5 and the casing 1 is reduced to cause the screw rotor 5 and the casing 1 to come into contact with each other and to result in seizure. Therefore, in the refrigeration cycle apparatus 100, when the discharge temperature detected by the temperature detector 107 reaches a set value, in order to prevent the discharge temperature of the screw compressor 101 from rising excessively, the flow passage opening and closing device 106 is opened by the controller 105. Then, the refrigerant liquid is injected into the compression chambers 40. The value at which the discharge temperature is set is, for example, about 90 degrees C.

### (At the Time of Starting Up Screw Compressor 101)

Next, the injection control at the time of starting up the screw compressor 101 will be explained with reference to FIG. 5. As illustrated in FIG. 5, after the screw compressor 101 starts up, in order to reduce the amount of a starting current, the operating capacity is gradually increased until the target operating capacity is reached. The electric motor 2, which is an inverter electric motor, controls the operating capacity by controlling the rotational speed of the motor. In the electric motor 2, which is a constant-speed electric motor, the operating capacity is controlled by controlling the slide valves 7. When controlling the operating capacity by the slide valves 7, the operating capacity may be changed stepwise, not changed continuously as shown in FIG. 5.

Meanwhile, in the refrigeration cycle apparatus 100, when the screw compressor 101 starts up, the suction pressure of the compressor tends to drop, and the operation is performed at a lower capacity, and hence, the amount of refrigerant circulating may be reduced. Generally, when the discharge temperature is prevented from rising to an abnormally high temperature in the injection circuit 201, the flow rate of the injection circuit 201 is controlled by using a temperature-sensitive expansion valve, or, by using values detected by the discharge temperature sensor, refrigerant liquid is supplied to the compression chambers 40 via the injection circuit 201 such that the discharge temperature does not exceed the set temperature. However, in these controls, when the screw compressor 101 starts up, the amount of refrigerant circulating is small, and when the temperature and pressure suddenly change, the detection of the discharge temperature of the screw compressor 101 is delayed, and the reaction speed to open the temperature-sensitive expansion valve becomes slow. Therefore, a problem may arises that the refrigerant liquid from the injection passage is not sufficiently supplied to the compression chambers 40, and the discharge temperature rises excessively to cause the amount of expansion of the screw rotor 5 increases, and as a result, the screw rotor 5 and the casing 1 come into contact with each other and result in seizure.

Therefore, in the refrigeration cycle apparatus 100 according to Embodiment 1, at the time of starting up the screw compressor 101, when the detection of discharge temperature is likely to be delayed, the flow passage opening and closing device 106 is controlled regardless of the discharge temperature detected by the temperature detector 107, and refrigerant liquid is supplied to the compression chambers 40 via the injection circuit 201 and the injection flow passage 9 until the preset target operating capacity is reached or a preset time elapses after the screw compressor 101 starts up. However, when the operating capacity is gradually increased, it suffices that control be performed to a certain stage.

Therefore, in the refrigeration cycle apparatus 100 according to Embodiment 1, a sufficient amount of the refrigerant liquid can be supplied to the compression chambers 40 even when the screw compressor 101 starts up, and an abnormal rise in the discharge temperature can be suppressed. Therefore, the refrigeration cycle apparatus 100 according to Embodiment 1 can reduce occurrence of a situation in which, at the time of starting up the compressor 101, due to a reduction of a gap between the screw rotor and the casing, the screw rotor and the casing contact with each other and suffer from seizure, whereby a high degree of reliability can be obtained.

In the refrigeration cycle apparatus 100 described above, the screw compressor is described as an example of the compressor 101, but the compressor 101 is not limited to the screw compressor. The compressor 101 may be, for example, a rotary compressor, a scroll compressor, or other compressors.

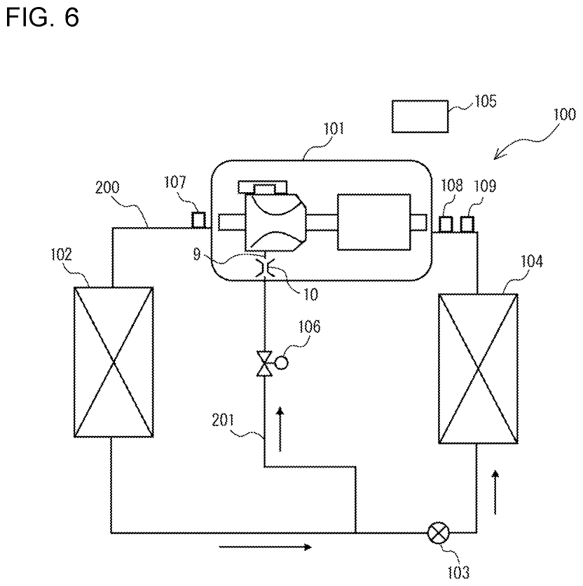

FIG. 6 is a refrigerant circuit diagram illustrating a modification example of the refrigeration cycle apparatus according to Embodiment 1, The refrigeration cycle apparatus 100 illustrated in FIG. 6 further includes the temperature detector 108 configured to detect the temperature of the refrigerant sucked into the screw compressor 101 and the pressure detector 109 configured to detect the pressure of refrigerant sucked into the screw compressor 101. The temperature detector 108 is, for example, a temperature sensor. The pressure detector 109 is, for example, a pressure sensor. When the screw compressor 101 starts up, the controller 105 calculates a degree of suction superheat of refrigerant based on values detected by the temperature detector 108 and the pressure detector 109, and when the degree of suction superheat is equal to or lower than the target temperature, controls the flow passage opening and closing device 106 to stop supply of refrigerant liquid to the compression chambers 40 via the injection circuit 201 and the injection flow passage 9, With such a configuration, the refrigeration cycle apparatus 100 can prevent oversupply of refrigerant liquid.

### Embodiment 2

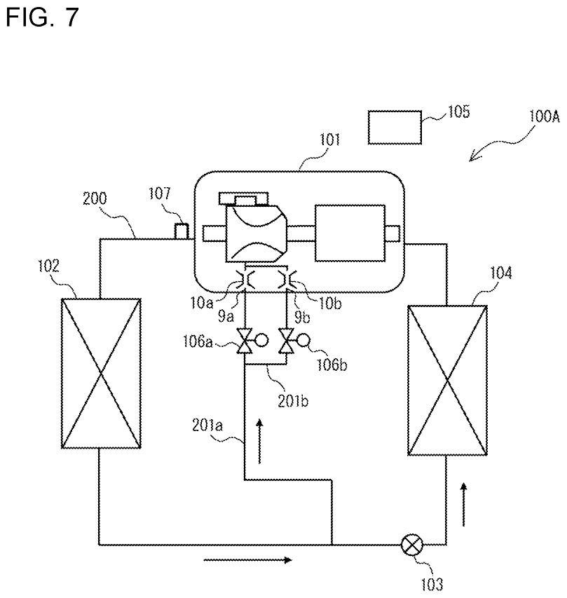

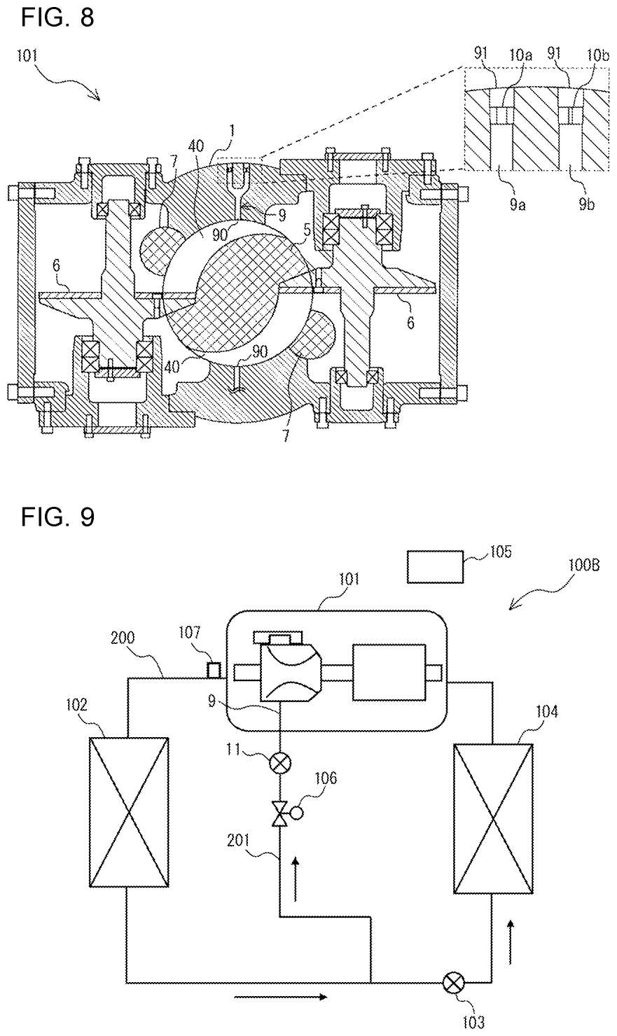

Next, a refrigeration cycle apparatus 100A according to Embodiment 2 will be described with reference to FIGS. 7 and 8. FIG. 7 is a refrigerant circuit diagram of the refrigeration cycle apparatus according to Embodiment 2. FIG. 8 is a cross-sectional view schematically illustrating a screw compressor of the refrigeration cycle apparatus according to Embodiment 2. The same components as those of the refrigeration cycle apparatus 100 described in Embodiment 1 are designated by the same reference signs, and the description thereof will be omitted as appropriate.

As illustrated in FIGS. 7 and 8, in the refrigeration cycle apparatus 100A according to Embodiment 2, the injection flow passage 9 has a first injection flow passage 9a and a second injection flow passage 9b each leading to the compression chambers 40. The first injection flow passage 9a and the second injection flow passage 9b merge inside the casing 1 into a single injection flow passage, and this single injection flow passage is connected to the compression chambers 40. Further, the injection circuit 201 has a first injection circuit 201a, which branches off from the refrigerant cycle circuit 200 between the condenser 102 and the pressure-reducing device 103 and is connected to the first injection flow passage 9a, and a second injection circuit 201b, which branches off from the first injection circuit 201a and is connected to the second injection flow passage 9b.

The flow rate control device includes a first fixed expansion component 10a provided in the first injection flow passage 9a and a second fixed expansion component 10b provided in the second injection flow passage 9b. The first fixed expansion component 10a and the second fixed expansion component 10b are each, for example, an orifice plug or the like. The second fixed expansion component 10b has a smaller diameter of a hole for adjusting the flow rate, as compared with the first fixed expansion component 10a. Therefore, the amount of the refrigerant liquid supplied by the second injection flow passage 9b is smaller than the amount of the refrigerant liquid supplied by the first injection flow passage 9a. The first fixed expansion component 10a may have a configuration in which, for example, a capillary tube or the like is installed in the first injection circuit 201a in addition to the orifice plug. Similarly, the second fixed expansion component 10b may have a configuration in which, for example, a capillary tube or the like is installed in the second injection circuit 201b in addition to the orifice plug.

The flow passage opening and closing device 106 is formed of a first flow passage opening and closing device 106a provided in the first injection circuit 201a and a second flow passage opening and closing device 106b provided in the second injection circuit 201b. The first flow passage opening and closing device 106a is provided in an area between a position where the second injection circuit 201b branches off and a position where it is connected to the first injection flow passage 9a. The first flow passage opening and closing device 106a and the second flow passage opening and closing device 106b are, for example, solenoid valves.

In the refrigeration cycle apparatus 100A according to Embodiment 2, for example, the liquid refrigerant is supplied to the compression chambers 40 via the first injection circuit 201a during the normal operation of the screw compressor 101, On the other hand, when the screw compressor 101 starts up, the liquid refrigerant is supplied to the compression chambers 40 via the second injection circuit 201b. That is, in the refrigeration cycle apparatus 100A according to Embodiment 2, by properly using the first injection circuit 201a and the second injection circuit 201b depending on the application, orifice plugs having different hole diameters can be used properly.

Therefore, in the refrigeration cycle apparatus 100A according to Embodiment 2, excessive supply of refrigerant liquid at the time of starting up the screw compressor 101 is suppressed, and an appropriate injection is performed to suppress an abnormal rise in the discharge temperature with excessive compression of the liquid being suppressed, whereby a higher degree of reliability can be ensured. Of course, the discharge temperature can be controlled stepwise by using the first injection circuit 201a and the second injection circuit 201b for the injection control during the normal operation of the screw compressor 101.

The injection flow passage 9 and the injection circuit 201 are not limited to the two illustrated. Although not illustrated, the injection flow passage 9 may have three or more flow passages each leading to the compression chambers 40. In this case, the injection circuit 201 has three or more circuits that branch off from the refrigerant cycle circuit 200 between the condenser 102 and the pressure-reducing device 103 and each of the branched circuits is connected to a corresponding one passage of the injection flow passage 9.

Further, in the refrigeration cycle apparatus 100A described above, the screw compressor is described as an example of the compressor 101, but the compressor 101 is not limited to the screw compressor. The compressor 101 may be, for example, a rotary compressor, a scroll compressor, or other compressors.

Although not illustrated, the refrigeration cycle apparatus 100A according to Embodiment 2 may be provided with the temperature detector 108 and the pressure detector 109 illustrated in FIG. 6. When the screw compressor 101 starts up, the controller 105 calculates the degree of suction superheat of the refrigerant based on values detected by the temperature detector 108 and the pressure detector 109, and when the degree of suction superheat is equal to or lower than the target temperature, the flow passage opening and closing device 106 is controlled to stop supply of the refrigerant liquid to the compression chambers 40 via the injection circuit 201 and the injection flow passage 9.

### Embodiment 3

Next, the refrigeration cycle apparatus 100E according to Embodiment 3 will be described with reference to FIG. 9. FIG. 9 is a refrigerant circuit diagram of the refrigeration cycle apparatus according to Embodiment 3. The same components as those of the refrigeration cycle apparatus 100 described in Embodiment 1 and the refrigeration cycle apparatus 100, described in Embodiment 2 are designated by the same reference signs, and the description thereof will be omitted as appropriate.

The refrigeration cycle apparatus 100E according to Embodiment 3 has a configuration in which an electronic expansion valve 11 is installed as a flow rate control device in the injection circuit 201. By using the electronic expansion valve 11 as the flow rate control device, the opening degree can be controlled freely. It should be noted that, in the refrigeration cycle apparatus 100E according to Embodiment 3 illustrated in FIG. 9, it is not required to completely close the injection circuit 201, or if the injection circuit 201 can be completely closed by the electronic expansion valve 11, provision of the flow passage opening and closing device 106 may be omitted.

The controller 105 of the refrigeration cycle apparatus 100E according to the Embodiment 3 controls the electronic expansion valve 11 based on values detected by the temperature detector 107 such that a discharge temperature of refrigerant gas or the degree of superheat of the discharge gas discharged from the screw compressor 101 becomes constant during the normal operation of the screw compressor 101.

In the controller 105 of the refrigeration cycle apparatus 100E of Embodiment 3, by opening the electronic expansion valve 11 so that it has a preset opening degree and by supplying the liquid refrigerant to the compression chambers 40 during the capacity control operation after starting up the screw compressor 101 when detection of the discharge temperature thereof tends to be delayed, it is possible to prevent an abnormal rise in the discharge temperature. The preset opening degree means an opening degree that is adjusted such that a sufficient amount of liquid refrigerant is supplied so as to prevent the screw rotor 5 from contacting the casing 1 due to thermal expansion, and such that the liquid refrigerant is prevented from being supplied excessively to thereby prevent an excessive liquid compression state.

As described above, by the refrigeration cycle apparatus 100B according to Embodiment 3, the same advantageous effect as that obtained in Embodiment 1 can be obtained, and by using the electronic expansion valve 11 as the flow rate control device, the amount of liquid refrigerant to be injected into the compression chambers 40 can be finely controlled, and a higher degree of reliability can be obtained.

In the refrigeration cycle apparatus 100B described above, the screw compressor is described as an example of the compressor 101, but the compressor 101 is not limited to the screw compressor. The compressor 101 may be, for example, a rotary compressor, a scroll compressor, or other compressors.

Further, although not illustrated, to the configuration of the refrigeration cycle apparatus 100A of Embodiment 2, the configuration of the refrigeration cycle apparatus 100E according to Embodiment 3 can be applied. Specifically, instead of the fixed expansion components 10a and 10b illustrated in FIGS. 7 and 8, the electronic expansion valve 11 is provided in each of the first injection circuit 201a and the second injection circuit 201b. The electronic expansion valve 11 of the first injection circuit 201a is provided between the first flow passage opening and closing device 106a and the first injection flow passage 9a. The electronic expansion valve 11 of the second injection circuit 201b is provided between the second flow passage opening and closing device 106b and the second injection flow passage 9b.

Although not illustrated, the refrigeration cycle apparatus 100B according to the Embodiment 3 may be provided with the temperature detector 108 and the pressure detector 109 illustrated in FIG. 6. When the screw compressor 101 starts up, the controller 105 calculates the degree of suction superheat of refrigerant based on values detected by the temperature detector 108 and the pressure detector 109, and when the degree of suction superheat is equal to or lower than the target temperature, the flow passage opening and closing device 106 is controlled to stop supply refrigerant liquid to the compression chambers 40 via the injection circuit 201 and the injection flow passage 9.

Although the refrigeration cycle apparatus (100, 100A, 100B) is described above based on the embodiments, the configuration of the refrigeration cycle apparatus (100, 100A, 100B) is not limited to the configuration of the above-described embodiments. For example, the components used in the refrigeration cycle apparatus (100, 100A, 100B) are not limited to the above-mentioned components, and may include other components. In addition, the magnitude of the pressure is not particularly determined in relation to an absolute value, but is relatively determined in the state, operation or other factors of the system and the device. In short, the refrigeration cycle apparatus (100, 100A, 1003) may be varied in design and application conducted normally by a person skilled in the art within a range that is not deviated from the gist of the technical idea.

### REFERENCE SIGNS LIST

1:casing, 1a slide groove, 2: electric motor, 2a: stator, 2b: motor rotor, 3: screw shaft, 4: compression mechanism, 5: screw rotor, 5a: screw groove, 6: gate rotor, 6a: gate rotor teeth, 7: slide valve, 7a: discharge port, 8: bypass drive unit, 9: injection flow passage, 9a: first injection flow passage, 9b: second injection flow passage, 10: fixed expansion component (flow rate control device), 11: electronic expansion valve (flow rate control device), 10a: first fixed expansion component, 10b: second fixed expansion component, 30: bearing, 40: compression chamber, 70: connection rod, 90: injection port, 91: connection port, 100,100A,100B: refrigeration cycle apparatus, 101: screw compressor, 102: condenser, 103: pressure-reducing device, 104: evaporator, 105: controller, 106: flow passage opening and closing device (flow rate control device), 106a: first flow passage opening and closing device, 106b: second flow passage opening and closing device, 107: temperature detector, 108: temperature detector, 109: pressure detector, 200: refrigerant cycle circuit, 201: injection circuit, 201a: first injection circuit, 201b: second injection circuit, S1: low-pressure space, S2: high-pressure space

1. A refrigeration cycle apparatus comprising:
a refrigerant cycle circuit in which a screw compressor including a compression chamber configured to compress refrigerant and an injection flow passage that leads to the compression chamber, a condenser, a pressure-reducing device and an evaporator are sequentially connected by pipes;
an injection circuit that branches off from the refrigerant cycle circuit between the condenser and the pressure-reducing device and is connected to the injection flow passage;
a flow rate control device provided in the injection circuit or the injection flow passage; and
a controller configured to control the flow rate control device, wherein,
at a time of starting up the screw compressor, the controller is configured to control, regardless of a temperature of refrigerant discharged from the screw compressor, the flow rate control device so as to supply refrigerant liquid to the compression chamber via the injection circuit and the injection flow passage until an operating capacity of the screw compressor reaches a preset operating capacity.

2. The refrigeration cycle apparatus of claim 1, wherein the flow rate control device includes a flow passage opening and closing device provided in the injection circuit and is configured to open and close the injection circuit, and
a fixed expansion component provided in the injection flow passage or the injection circuit.

3. The refrigeration cycle apparatus of claim 1, wherein the flow rate control device is an electronic expansion valve provided in the injection circuit.

4. The refrigeration cycle apparatus of claim 1, further comprising a temperature detector configured to detect a temperature of refrigerant sucked in the screw compressor and a pressure detector configured to detect a pressure of refrigerant sucked in the screw compressor, wherein the controller, at the time of starting up the screw compressor, is configured to calculate a degree of suction superheat of the refrigerant based on values detected by the temperature detector and the pressure detector, and, when the degree of suction superheat is equal to or lower than a target temperature, the controller is configured to control the flow rate control device to stop supply of refrigerant liquid to the compression chamber via the injection circuit and the injection flow passage.

5. The refrigeration cycle apparatus of claim 1, wherein the injection flow passage includes a plurality of flow passages each leading to the compression chamber, and wherein
the injection circuit includes a plurality of circuits that branch off from the refrigerant cycle circuit between the condenser and the pressure-reducing device and each of the branched circuits is connected to a corresponding one of the plurality of flow passages of the injection flow passage.

6. The refrigeration cycle apparatus of claim 5, wherein the injection flow passage includes a first injection flow passage and a second flow passage each leading to the compression chamber, and
the injection circuit includes a first injection circuit that branches off from the refrigerant cycle circuit between the condenser and the pressure-reducing device and is connected to the first injection flow passage, and a second injection circuit that branches off from the first injection circuit and is connected to the second injection flow passage.

7. The refrigeration cycle apparatus of claim 1, wherein the screw compressor includes an inverter electric motor, and the controller, at the time of starting up the screw compressor, is configured to control the flow rate control device, and to control the operating capacity by controlling a motor rotation speed of the electric motor.

8. The refrigeration cycle apparatus of claim 1, wherein the screw compressor includes:
an electric motor, which is a constant speed electric motor;
a screw shaft configured to rotate by the electric motor;
a screw rotor that has screw grooves, which are helically shaped, on its outer peripheral surface, and is fixed to the screw shaft;
a gate rotor that has, on its outer periphery, a plurality of gate rotor teeth which are configured to mesh with the screw grooves of the screw rotor; and
a slide valve configured to slide freely in a direction of a rotational axis of the screw rotor, wherein
the controller is, at a time of starting up the screw compressor, configured to control the flow rate control device, and to control the operating capacity by controlling the slide valve.
